(19) United States
(12) Patent Application Publication
(10) Pub. No.: US 2002/0012463 A1
(43) Pub. Date: Jan. 31, 2002

(54) Apparatus and method for acquiring images using a solid-state image sensor and recording medium having recorded thereon a program for executing the method

(75) Inventor: Makoto Yamada, Kanagawa (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: FUJI PHOTO FILM CO., LTD.

(21) Appl. No.: 09/877,121

(22) Filed: Jun. 11, 2001

(30) Foreign Application Priority Data
Jun. 9, 2000 (JP) 2000-173895

(51) Int. Cl. G06K 9/00; G06K 9/40

(52) U.S. Cl. 382/167; 382/274

(57) ABSTRACT

The image acquisition apparatus and method capture an image as digital image data by means of a solid-state image sensor and performing color correction on the captured image. The apparatus and method detect brightness of each area of the captured image and set coefficients of a color correcting matrix for performing said color correction in accordance with the detected brightness of each area of the captured image. The another apparatus and method set sensitivity of the solid-state image sensor and set coefficients of a color correcting matrix for performing the color correction in accordance with the sensitivity of the solid-state image sensor. The recording medium which has a program for computer execution of the above-described image acquisition method recorded thereon such that the program can be red by a computer.

### BACKGROUND OF THE INVENTION

This invention relates to an apparatus and a method for acquiring images using a solid-state image sensor, as well as a recording medium having recorded thereon a program for executing the method. The invention relates particularly to the technology of reducing noise that would otherwise increase when a dark subject were taken with an apparatus such as a digital still camera that captures still image with a CCD (charge coupled device).

Conventional image recording apparatus such as photographic cameras record image on films but they are increasingly supplanted today by a new class of image acquisition apparatus such as digital still cameras, commonly called “digital cameras”, which use solid-state image sensors such as CCD to take a picture of the subject and which transform the obtained luminance signals to digital image data to be stored on a recording medium.

The signal output from digital cameras is digital image data typically expressed in 8-bit digital values. This data is taken into an image processor (personal computer or PC) and subjected to specified image processing steps so that it is either displayed on the monitor such as CRT (cathode ray tube) or output as a print (hard copy) from the printer.

In most models of digital cameras that can shoot color image, signals output from a CCD are subjected to various color correcting schemes to produce the final output image. Among the conventionally known color correcting schemes are linear matrix processing and color difference matrix processing. In linear matrix processing, the signals output from the CCD which are linear to the luminance of the subject are processed by operation of a 3×3 matrix (linear matrix). In color difference matrix processing, the luminance-linear signals are subjected to gamma-transformation in conformity with CRT monitor characteristics and two kinds of signals, luminance signal and color difference signal, are obtained from the γ-transformed signals and the color difference signal is processed by, for example, a 2×2 matrix (color difference matrix). The linear matrix is advantageous for assuring correct color reproduction. Since luminance noise is more conspicuous than color noise, the color difference matrix which does not alter luminance signals is advantageous in noise suppression.

Signals output from the CCD usually contain noise. The predominant noise components are shot noise and noise from the dark current through the CCD. Shot noise is proportional to the square root of the quantity of light incident on the CCD whereas noise from the dark current through the CCD is also called fixed noise and independent of the quantity of incident light. The smaller the quantity of light that is incident on the CCD, the higher the proportion of noise that is contained in the signal.

The linear matrix and the color difference matrix have a noise amplifying effect and the larger the absolute values of the matrix coefficients, the greater the noise amplifying effect. However, current models of digital cameras use a fixed matrix irrespective of how much light is incident on the CCD and this produces pronounced noise in the dark areas of the subject. If sensitivity setting values are high, there occurs pronounced noise all over the image.

### SUMMARY OF THE INVENTION

The present invention has been accomplished in view of these circumstances and has as an object providing an apparatus that acquire images using a solid-state image sensor such as CCD and which is capable of suppressing the noise contained in the digital image data captured with the solid-state image sensor.

Another object of the invention is to provide a method that can be implemented by the apparatus.

Still another object of the invention is to provide a recording medium having recorded thereon a program for executing the method.

In order to attain the object described above, the first aspect of the present invention provides an image acquisition apparatus, comprising: a solid-state image sensor for capturing an image as digital image data; a color correction device for performing color correction on the image captured by the solid-state image sensor; a brightness detecting device for detecting brightness of each area of the captured image; and a first matrix coefficient setting device for setting coefficients of a color correcting matrix by which the color correction device performs the color correction on the captured image in accordance with the detected brightness of each area of the captured image by the solid-state image sensor.

Preferably, the first matrix coefficient setting device sets the coefficients of the color correcting matrix to have increased absolute values in bright areas of the image detected by the brightness detecting device, but have reduced absolute values in dark areas of the image detected by the brightness detecting device.

Preferably, the color correction device includes as the color correcting matrix a linear matrix and a color difference matrix and the first matrix coefficient setting device alters the coefficients of the linear matrix and the color difference matrix in accordance with the detected brightness of each area of the image.

Preferably, the first matrix coefficient setting device sets the coefficients of the linear matrix to have increased absolute values in bright areas of the image detected by the brightness detecting device, but the coefficients of the linear matrix to have reduced absolute values and the coefficients of the color difference matrix to have increased values in dark areas detected by the brightness detecting device.

Preferably, the brightness detecting device detects any one of brightness, luminance and illuminance as the brightness of each area of the captured image.

It is preferable that the image acquisition apparatus further comprises: a recording device for recording the digital image data of the captured image corrected by the color Correction device on an image recording medium.

In order to attain the object described above, the second aspect of the present invention provides an image acquisition apparatus, comprising: a solid-state image sensor for capturing an image as digital image data; a color correction device for performing color correction on the image captured by the solid-state image sensor; a sensitivity setting device for setting sensitivity of the solid-state image sensor; and a second matrix coefficient setting device for setting coefficients of a color correcting matrix by which the color correction device performs the color correction on the captured image in accordance with the set sensitivity of the solid-state image sensor by the sensitivity setting device.

Preferably, the second matrix coefficient setting device sets the coefficients of the matrix to have increased absolute values if the set sensitivity of the solid-state image sensor is low, but have reduced absolute values if the set sensitivity of the solid-state image sensor is high.

Preferably, the color correction device includes as the color correcting matrix a linear matrix and a color difference matrix and the second matrix coefficient setting device alters the coefficients of the linear matrix and the color difference matrix in accordance with the set sensitivity of the solid-state image sensor.

Preferably, the second matrix coefficient setting device sets the coefficients of the linear matrix to have increased absolute values if the set sensitivity is low, but the coefficients of the linear matrix to have reduced absolute values and the coefficients of the color difference matrix to have increased values if the set sensitivity is high.

It is preferable that the image acquisition apparatus further comprises: a recording device for recording the digital image data of the captured image corrected by the color correction device on an image recording medium. In order to attain another object described above, the third aspect of the present invention provides an image acquisition method, comprising the steps of: capturing an image as digital image data by means of a solid-state image sensor; performing color correction on the image captured by the solid-state image sensor; detecting brightness of each area of the captured image; and setting coefficients of a color correcting matrix for performing the color correction in accordance with the detected brightness of each area of the captured image.

Preferably, the coefficients of the color correcting matrix are set to have increased absolute values in bright areas of the image detected by the brightness detecting device, but have reduced absolute values in dark areas of the image detected by the brightness detecting device.

Preferably, the color correcting matrix includes a linear matrix and a color difference matrix and the coefficients of the linear matrix and the color difference matrix are altered in accordance with the brightness of each area of the image.

Preferably, the coefficients of the linear matrix are set to have increased absolute values in bright areas of the image, but the coefficients of the linear matrix are set to have reduced absolute values and the coefficients of the color difference matrix are set to have increased values in dark areas.

Preferably, the brightness is any one of lightness, luminance and illuminance.

It is preferable that the image acquisition method further comprises the step of: recording the digital image data of the captured image corrected by the color correction on an image recording medium.

In order to attain another object described above, the fourth aspect of the present invention provides an image acquisition method, comprising the steps of: capturing an image as digital image data by means of a solid-state image sensor; and performing color correction on the image captured by the solid-state image sensor; the method further including the step of: setting coefficients of a color correcting matrix for performing the color correction in accordance with sensitivity of the solid-state image sensor.

Preferably, the coefficients of the color correcting matrix are set to have increased absolute values if the sensitivity of the solid-state image sensor is low, but have reduced absolute values if the sensitivity of the solid-state image sensor is high.

Preferably, the color correcting matrix includes a linear matrix and a color difference matrix and the coefficients of the linear matrix and the color difference matrix are altered in accordance with the sensitivity of the solid-state image sensor.

Preferably, if the sensitivity of the solid-state image sensor is low, the coefficients of the linear matrix are set to have increased absolute values, but if the sensitivity of the solid-state image sensor is high, the coefficients of the linear matrix are set to have reduced absolute values and the coefficients of the color difference matrix are set to have increased values.

It is preferable that the image acquisition method further comprises the step of: recording the digital image data of the captured image corrected by the color correction on an image recording medium.

In order to attain still another object described above, the fifth aspect of the present invention provides a recording medium which has a program for computer execution of an image acquisition method recorded thereon such that the program can be read by a computer, the method comprising the steps of: capturing an image as digital image data by means of a solid-state image sensor; performing color correction on the image captured by the solid-state image sensor; detecting brightness of each area of the captured image; and setting coefficients of a color correcting matrix for performing the color correction in accordance with the detected brightness of each area of the captured image.

In order to attain still another object described above, the sixth aspect of the present invention provides a recording medium which has a program for computer execution of an image acquisition method recorded thereon such that the program can be read by a computer, the method comprising the steps of: capturing an image as digital image data by means of a solid-state image sensor; and performing color correction on the image captured by the solid state image sensor; the method further including the step of: setting coefficients of a color correcting matrix for performing the color correction in accordance with sensitivity of the solid-state image sensor.

### BRIEF DESCRIPTION OF THE DRAWINGS

FIG. 1 is a block diagram showing the general configuration of an apparatus for acquiring images using a solid-state image sensor according to an embodiment of the invention; and

FIG. 2 is a graph showing the spectral sensitivity characteristics of the CCD used in the embodiment.

### DESCRIPTION OF THE PREFERRED EMBODIMENT

The apparatus and method for acquiring images using a solid-state image sensor and a recording medium having recorded thereon a program for executing the method are described below in detail with reference to the preferred embodiment shown in the accompanying drawings.

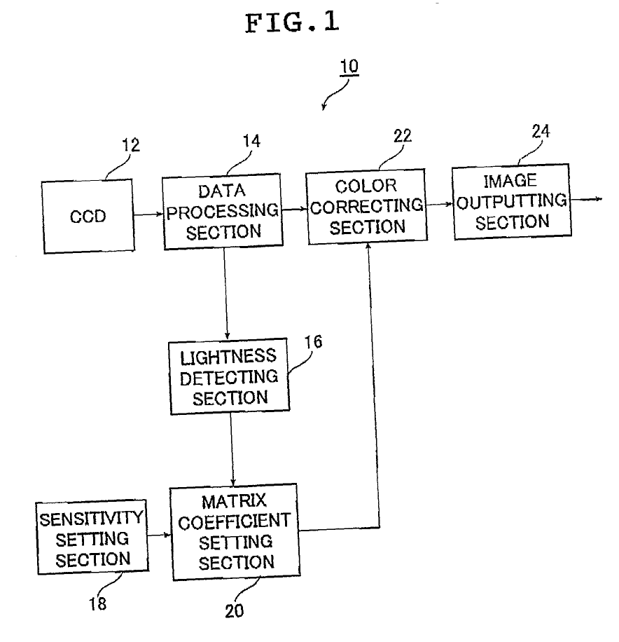

FIG. 1 is a block diagram showing the general configuration of an apparatus for acquiring images using a solid-state image sensor according to an embodiment of the invention. The apparatus generally indicated by 10 comprises a COD 12, a data processing sect on 14, a lightness detecting section 16, a sensitivity setting section 18, a matrix coefficient setting section 20, a color correcting section 22, and an image outputting section 24.

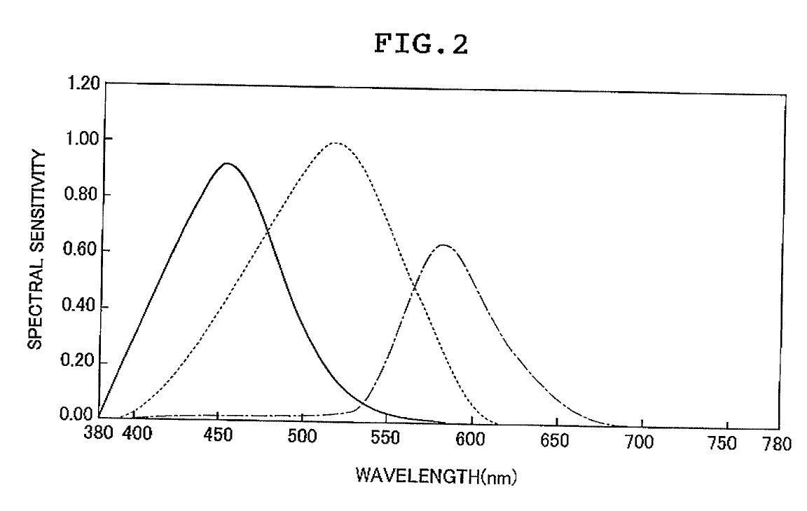

CCD 12 is an imaging device capable of acquiring color image and is assumed to have the spectral sensitivity characteristics shown in FIG. 2 by a solid curve (B or blue), a dashed line (G or green) and a one-long-and-one-short dashed line (R or red). In the data processing section 14, the image signal input from the CCD 12 is subjected to A/D conversion to produce digital image data which in turn is subjected to the correction of white balance and other processing steps. In the lightness detecting section 16, R, G and B signals that have been corrected fox white balance (subjected to gain correction) are processed to detect the lightness of each area of the image by calculating the linear sum in accordance with the following equation (1):

Y=3×R+6×G+B (1)

The sensitivity setting section 18 sets the sensitivity for the CCD 12 to have during shooting. The setting (sensitivity setting value) is high for a dark image and low for a bright image.

The matrix coefficient setting section 20 obtains the information from the lightness detecting section 16 or the sensitivity setting section 18 and sets the coefficients of a color correcting matrix (linear matrix or color difference matrix) in accordance with the detected lightness or the set sensitivity. In the color correcting section 22, the image data is subjected to color correcting steps using the color correcting matrix set in the matrix setting section 20. The processed image data is output from the image outputting section 24 to a specified image recording medium such as a memory card, hard disk or an internal memory depending on what the image data is to be used for.

The preferred embodiment of the invention is described more specifically. Assuming that the standard light source is D65 specified by the CIE, the R, G and B channels are given the following exposures relative to white light having a reflectance of 1.0 at each wavelength:

R: 0.375

C: 1.000

S: 0.693

Note that these values are normalized by the amount of exposure for G channel which is given a maximum exposure.

Suppose here that the CCD 12 is saturated with an electric charge of 20,000 e. If quantity of output electric charge from G channel which is given a maximum exposure relative to white light is made equal to the saturated charge, the R, G and B channels will generate the following quantities of electric charge since the given exposure is proportional to the quantity of generated charge:

R: 7,500 e G: 20,000 e B: 13,860 e

Also assume that the noise generated from the CCD 12 is determined by shot noise Ns which is proportional to the square root of the quantity of electric charge and fixed noise Nd which is not dependent on the quantity of electric charge. The amount of noise N generated in each channel is given by the following equation (2):

N=(Ns²+Nd²)^{½} (2)

where Ns=S^{½} (S is the quantity of generated electric charge).

Therefore, if Nd is 5 e, the respective channels will have the following amounts of noise:

R: 86.9 e

G: 141.5 e

B: 117.8 e

To give white balance, multiplication by the following gains is performed for the respective channels:

R: 2.67

G: 1.00

B: 1.44

As a result, the respective channels will have the following amounts of noise:

R: 231.3

G: 141.5

B: 170.0

The quantities of electric charge generated from the respective channels are multiplied by the associated gains to give the following signal values:

R=7,500×2.67=20,025

G=20,000×1.00=20,000

B=13,860×1.44=19,958

The linear matrix expressed by the following equation (3) is operated upon those signal values:

$$[ \begin{matrix}{R}^{′} \\ {G}^{′} \\ {B}^{′}\end{matrix} ] = [ \begin{matrix}1.96 & - 1.65 & 0.68 \\ 0.03 & 1.80 & - 0.83 \\ - 0.07 & - 0.26 & 1.33\end{matrix} ] [ \begin{matrix}R \\ G \\ B\end{matrix} ] \qquad ( 3 )$$

As a result, the respective channels generate the following quantities of electric charge:

R′=19,820

G′=20,035

B′=19,943

The amount of noise contained in each channel is expressed by the square root of the square sum of the noise in each channel before the linear matrix is operated upon; hence, the R, G and B channels contain the following amounts of noise:

R: 522.9

G: 291.3

B: 229.7

If the quantity of signal charge in each channel i (i=R, G, B) is written as Ei and the amount of noise in each channel as Ni, the signal to noise ratio (S/N) is given by the following equation (4):

S/N=20×log(Ei/Ni) (4)

Substituting the relevant values into equation (4), we obtain the following S/N ratios for the respective channels:

R=20×log(19,820/522.9)=31.7

S=20×log(20,035/291.3)=36.7

B=20×log(19,943/229.7)=38.8

Consider here a subject having a reflectance of 0.05 (5%) at each wavelength and perform the same calculations as described above. The result is:

R: 18.4

G: 23.6

B: 25.6

Obviously, dark colors having a low reflectance of 5% suffer increased noise to give significantly lowered S/N ratios.

To deal with this problem, the coefficients of the linear matrix (3) are made smaller in absolute value as

R′=1.00 0.00 0.00 R

C′=0.00 1.00 0.00 G

B′0.00 0.00 1.00 B

shown by the following equation (5):

Similar calculations by equation (5) give the following result for the noise of the object having a reflectance of 5%:

R: 25.5

A: 29.9

B: 28.3

Thus, using a linear matrix with coefficients of smaller absolute values, one can obtain higher S/N ratios or reduce the noise in the image taken with a CCD.

A problem with this approach of reducing the coefficients of a linear matrix for image areas with lower luminance is its potential to lower the saturation of low-luminance colors. To deal with this problem, the use of a color difference matrix having increased coefficients in combination with the linear matrix with reduced absolute values of coefficients is recommended for image areas of lower luminance and one can obtain an image that has high enough color saturation in the low-luminance areas while avoiding amplification of noise in achromatic colors. To be more specific, a linear matrix with coefficients of increased absolute values is used for bright image areas (of high lightness) whereas the absolute values of the coefficients of the linear matrix are reduced and a color difference matrix with increased coefficients is used for dark areas (of low lightness) and this offers the significant advantage of producing an image having less pronounced noise in the dark areas.

To assign bright and dark areas, a threshold may be determined by calculation trom Y=3×R+6×G+B

If the image is simply divided into bright and dark areas which are assigned matrix coefficients of different values, a false contour may occur in those image areas where lightness changes continuously. To avoid this possibility, the matrix coefficients are preferably altered depending on the brightness value Y which is defined by equation (1).

To give an example, consider an image having a maximum brightness value Yₘₐₓ and a minimum brightness value Yₘᵢₙ and assume the use of a matrix having the largest absolute value of coefficients set at aᵢⱼₘₐₓ and the smallest absolute value at aᵢⱼₘᵢₙ. If the pixel of interest in the image has a brightness value of Y, each matrix coefficient aᵢⱼ may be determined by the following equation (6):

aᵢⱼ=(aᵢⱼₘₐₓ−aᵢⱼₘᵢₙ)×(Y−Yₘᵢₙ)/(Yₘₐₓ−Yₘᵢₙ )+aᵢⱼₘᵢₙ (6)

This is the method of linear allotment of matrix coefficients in accordance with image brightness.

While the above example concerns the case of setting value the matrix coefficients in accordance with image lightness, they may be set in accordance with the sensitivity setting value of the apparatus. In this alternative case, the higher the lightness of image, the lower the sensitivity of the apparatus is set to have and vice versa. Hence, with low sensitivity, the coefficients of a linear matrix are set to have increased absolute values and with high sensitivity, they have reduced absolute values whereas the coefficients of a color difference matrix are set at increased values. This achieves the same result as setting matrix coefficients in accordance with image lightness and the noise in the image taken with CCD can be suppressed to a satisfactory low level.

In the example mentioned above, brightness in the image is represented by the brightness value of Y as defined by the equation (1) to divide the image into bright and dark areas, but this is not the sole case of the present invention. Since the equation (1) can be taken to represent approximate lightness or luminance, brightness may be represented in the present invention in terms of one of lightness, luminance and illuminance. Therefore, in the present invention, the lightness detecting device used may be the one for detecting brightness, or the brightness detecting device used may be the One for detecting one of lightness, luminance and iliuminance.

If desired, the image acquisition method according to the embodiment described above may be recorded on a recording medium as a program for its execution by a computer. Simply reading this program from the recording medium can attenuate the noise in a CCD input image.

While the apparatus and method of the invention for acquiring image using a solid-state image sensor and the recording medium having recorded on it a program for executing the method have been described above in detail, the invention is by no means limited to the foregoing example and various improvements and modifications may of course be made without departing from the scope and spirit of the invention.

As described on the foregoing pages, the noise contained in images taken with a solid-state image sensor such as CCD can be adequately suppressed in accordance with the present invention.

What is claimed is:

1. An image acquisition apparatus, comprising:
a solid-state image sensor for capturing an image as digital image data;
a color correction device for performing color correction on said image captured by said solid-state image sensor;
a brightness detecting device for detecting brightness of each area of the captured image; and
a first matrix coefficient setting device for setting coefficients of a color correcting matrix by which said color correction device performs said color correction on the captured image in accordance with the detected brightness of each area of the captured image by said solid-state image sensor.

2. The apparatus according to claim 1, wherein said first matrix coefficient setting device sets the coefficients of said color correcting matrix to have increased absolute values in bright areas of the image detected by said brightness detecting device, but have reduced absolute values in dark areas of the image detected by said brightness detecting device.

3. The apparatus according to claim 1, wherein said color correction device includes as said color correcting matrix a linear matrix and a color difference matrix and said first matrix coefficient setting device alters the coefficients of said linear matrix and said color difference matrix in accordance with the detected brightness of each area of said image.

4. The apparatus according to claim 3, wherein said first matrix coefficient setting device sets the coefficients of said linear matrix to have increased absolute values in bright areas of the image detected by said brightness detecting device, but the coefficients of said linear matrix to have reduced absolute values and the coefficients of said color difference matrix to have increased values in dark areas detected by said brightness detecting device.

5. The apparatus according to claim 1, wherein said brightness detecting device detects any one of brightness, luminance and illuminance as said brightness of each area of the captured image.

6. The apparatus according to claim 1, further comprising:
a recording device for recording the digital image data of the captured image corrected by said color correction device on an image recording medium.

7. An image acquisition apparatus, comprising:
a solid-state image sensor for capturing an image as digital image data;
a color correction device for performing color correction on said image captured by said solid-state image sensor;
a sensitivity setting device for setting sensitivity of said solid-state image sensor; and
a second matrix coefficient setting device for setting coefficients of a color correcting matrix by which said color correction device performs said color correction on the captured image in accordance with the set sensitivity of said solid-state image sensor by said sensitivity setting device.

8. The apparatus according to claim 7, wherein said second matrix coefficient setting device sets the coefficients of said matrix to have increased absolute values if the set sensitivity of said solid-state image sensor is low, but have reduced absolute values if said set sensitivity of said solid-state image sensor is high.

9. The apparatus according to claim 7, wherein said color correction device includes as said color correcting matrix a linear matrix and a color difference matrix and said second matrix coefficient setting device alters the coefficients of said linear matrix and said color difference matrix in accordance with the set sensitivity of said solid-state image sensor.

10. The apparatus according to claim 9, wherein said second matrix coefficient setting device sets the coefficients of said linear matrix to have increased absolute values if said set sensitivity is low, but the coefficients of said linear matrix to have reduced absolute values and the coefficients of said color difference matrix to have increased values if said set sensitivity is high.

11. The apparatus according to claim 7, further comprising:
a recording device for recording the digital image data of the captured image corrected by said color correction device on an image recording medium.

12. An image acquisition method, comprising the steps of:
capturing an image as digital image data by means of a solid-state image sensor;
performing color correction on said image captured by said solid-state image sensor;
detecting brightness of each area of the captured image; and setting coefficients of a color correcting matrix for performing said color correction in accordance with the detected brightness of each area of the captured image.

13. The method according to claim 12, wherein the coefficients of said color correcting matrix are set to have increased absolute values in bright areas of the image detected by said brightness detecting device, but have reduced absolute values in dark areas of the image detected by said brightness detecting device.

14. The method according to claim 12, wherein said color correcting matrix includes a linear matrix and a color difference matrix and the coefficients of said linear matrix and said color difference matrix are altered in accordance with the brightness of each area of said image.

15. The method according to claim 14, wherein the coefficients of said linear matrix are set to have increased absolute values in bright areas of the image, but the coefficients of said linear matrix are set to have reduced absolute values and the coefficients of said color difference matrix are set to have increased values in dark areas.

16. The method according to claim 12, wherein said brightness is any one of lightness, luminance and illuminance.

17. The method according to claim 12, further comprising the step of:
recording the digital image data of the captured image corrected by said color correction on an image recording medium.

18. An image acquisition method, comprising the steps of:
capturing an image as digital image data by means of a solid-state image sensor; and
performing color correction on said image captured by said solid-state image sensor;
said method further including the step of:
setting coefficients of a color correcting matrix for performing said color correction in accordance with sensitivity of said solid-state image sensor.

19. The method according to claim 18, wherein the coefficients of said color correcting matrix are set to have increased absolute values if the sensitivity of said solid-state image sensor is low, but have reduced absolute values if said sensitivity of said solid-state image sensor is high.

20. The method according to claim 18, wherein said color correcting matrix includes a linear matrix and a color difference matrix and the coefficients of said linear matrix and said color difference matrix are altered in accordance with the sensitivity of said solid-state image sensor.

21. The method according to claim 20, wherein, if the sensitivity of said solid-state image sensor is low, the coefficients of said linear matrix are set to have increased absolute values, but if said sensitivity of said solid-state image sensor is high, the coefficients of said linear matrix are set to have reduced absolute values and the coefficients of said color difference matrix are set to have increased values.

22. The method according to claim 18, further comprising the step of:
recording the digital image data of the captured image corrected by said color correction on an image recording medium.

23. A recording medium which has a program for computer execution of an image acquisition method recorded thereon such that said program can he read by a computer, said method comprising the steps of:
capturing an image as digital image data by means of a solid-state image sensor;
performing color correction on said image captured by said solid-state image sensor;
detecting brightness of each area of the captured image; and
setting coefficients of a color correcting matrix for performing said color correction in accordance with the detected brightness of each area of the captured image.

24. A recording medium which has a program for computer execution of an image acquisition method recorded thereon such that said program can be read by a computer, said method comprising the steps of:
capturing an image as digital image data by means of a solid-state image sensor; and
performing color correction on said image captured by said solid state image sensor;
said method further including the step of:
setting coefficients of a color correcting matrix for performing said color correction in accordance with sensitivity of said solid-state image sensor.
